(19) United States
(12) Patent Application Publication
(10) Pub. No.: US 2025/0168730 A1
(43) Pub. Date: May 22, 2025

(54) METHOD AND APPARATUS FOR HANDLING SLICE BASED CELL RESELECTION IN WIRELESS COMMUNICATION SYSTEM

(71) Applicant: Samsung Electronics Co., Ltd., Suwon-si, Gyeonggi-do (KR)

(72) Inventor: Aby Kanneath ABRAHAM, Bangalore (IN)

(21) Appl. No.: 18/832,732

(22) PCT Filed: Mar. 6, 2023
(86) PCT No.: PCT/KR2023/003038

§ 371 Date: Jul. 24, 2024

(30) Foreign Application Priority Data
Mar. 7, 2022 (IN) 202241012275
Feb. 15, 2023 (IN) 2022 41012275

(51) Int. Cl. H04W 36/00; H04W 36/24; H04W 36/36; H04W 48/08

(52) U.S. Cl. CPC H04W 36/13; H04W 36/24; H04W 36/36; H04W 48/08

(57) ABSTRACT

The disclosure relates to a 5G or 6G communication system for supporting a higher data transmission rate. Embodiments herein disclose methods N for handling a slice based cell reselection in a wireless network by a CE (100). The method includes receiving a slice based cell reselection information from a dedicated signaling message. Further, the method includes receiving a slice based cell reselection information from a broadcast signaling message. Further, the method includes storing and applying the slice based cell reselection information received from the dedicated signaling message and a part of the slice based cell reselection information from the broadcast signaling message. Further, the method includes avoiding storing and applying the at least one slice based priority for at least one frequencies and the at least one priority for the at least one frequency received from the broadcast signaling message.

### TECHNICAL FIELD

Embodiments disclosed herein relate to a wireless communication system (or wireless networks) or a mobile communication system (or, mobile networks). Particularly, the disclosures relate to methods and a apparatus for cell reselection with slices in the wireless communication networks.

### BACKGROUND ART

5G mobile communication technologies define broad frequency bands such that high transmission rates and new services are possible, and can be implemented not only in “Sub 6 GHZ” bands such as 3.5 GHZ, but also in “Above 6 GHZ” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, Al-based communication technology for implementing system optimization by utilizing satellites and AI (Artificial Intelligence) from the design stage and internalizing end-to-end Al support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

According to developments of communication system, there are needs to enhance cell reselection procedure with regard to network slice.

### Solution to Problem

According to an embodiment of the disclosure, a method performed by a terminal is provided. The method comprises: receiving, from a base station, a radio resource control (RRC) release message including information on a first cell reselection priority for slicing; receiving, from the base station, a system information block (SIB) for configuring a slice-based cell reselection, the SIB including information on a second cell reselection priority for slicing, information on a carrier frequency associated with the slice-based cell reselection, and information on a slice group; and identifying a cell reselection priority for the slice-based cell reselection, based on the first cell reselection priority for slicing, the carrier frequency associated with the slice-based cell reselection, and the slice group.

According to an embodiment of the disclosure, a method performed by a base station is provided. The method comprises: transmitting, to a terminal, a radio resource control (RRC) release message including information on a first cell reselection priority for slicing; and transmitting, to the terminal, a system information block (SIB) for configuring a slice-based cell reselection, the SIB including information on a second cell reselection priority for slicing, information on a carrier frequency associated with the slice-based cell reselection, and information on a slice group, wherein a cell reselection priority for the slice-based cell reselection is based on the first cell reselection priority for slicing, the carrier frequency associated with the slice-based cell reselection, and the slice group.

According to an embodiment of the disclosure, a terminal is provided. The terminal comprises: a transceiver; and a controller coupled with the transceiver and configured to: a transceiver; and a controller coupled with the transceiver and configured to: receive, from a base station, a radio resource control (RRC) release message including information on a first cell reselection priority for slicing, receive, from the base station, a system information block (SIB) for configuring a slice-based cell reselection, the SIB including information on a second cell reselection priority for slicing, information on a carrier frequency associated with the slice-based cell reselection, and information on a slice group, and identify a cell reselection priority for the slice-based cell reselection, based on the first cell reselection priority for slicing, the carrier frequency associated with the slice-based cell reselection, and the slice group.

According to an embodiment of the disclosure, a base station is provided. The base station comprises: a transceiver; and a controller coupled with the transceiver and configured to: transmit, to a terminal, a radio resource control (RRC) release message including information on a first cell reselection priority for slicing, and transmit, to the terminal, a system information block (SIB) for configuring a slice-based cell reselection, the SIB including information on a second cell reselection priority for slicing, information on a carrier frequency associated with the slice-based cell reselection, and information on a slice group, wherein a cell reselection priority for the slice-based cell reselection is based on the first cell reselection priority for slicing, the carrier frequency associated with the slice-based cell reselection, and the slice group.

Accordingly, the embodiments herein provide methods for handling a slice based cell reselection in a wireless network. The method includes receiving, by a UE, a slice based cell reselection information from a dedicated signaling message. The slice based cell reselection information received from the dedicated signaling message includes a list of slice groups, at least one supporting frequency and at least one slice based priority for the at least one frequency supporting a slice group. Further, the method includes receiving, by the UE, a slice based cell reselection information from a broadcast signaling message. The slice based cell reselection information received from the broadcast signaling message includes a list of slice groups, at least one supporting frequency, at least one slice based priority for the at least one frequency supporting a slice group, at least one priority for the at least one frequency, and a list of physical cell identifiers of at least one cell supporting the slice groups or un-supporting the slice groups. Further, the method includes storing and applying, by the UE, the slice based cell reselection information received from the dedicated signaling message and a part of the slice based cell reselection information from the broadcast signaling message. Further, the method includes avoiding, by the UE, storing and applying the at least one slice based priority for at least one frequencies and the at least one priority for the at least one frequency received from the broadcast signaling message.

In an embodiment, the part of the slice based cell reselection information stored and applied from the broadcast information includes the list of slice groups, the at least one supporting frequency, and the list of physical cell identifiers supporting or unsupporting the slice group.

Accordingly, the embodiments herein provide methods for handling a slice based cell reselection in a wireless network. The method includes receiving, by a UE, a slice based cell reselection information including a list of slice groups, a list of frequencies supporting a slice group and at least one slice specific frequency priority from a dedicated signaling message. The UE has not received any slice based cell reselection information from a broadcast signaling message from a current serving cell. Further, the method includes performing, by the UE, at least one of: performing a slice based cell reselection by considering all neighbor cells in all frequencies support all slice groups while the UE is camped to a serving cell, and does not performing the slice based cell reselection by considering that at least one neighbor cell does not support any of the slice groups provided in the dedicated signaling message during the slice based cell reselection.

In an embodiment, the UE keeps the slice based cell reselection information received from the dedicated signaling message while the UE is not performing slice based cell reselection in the serving cell which doesn't broadcast slice based cell reselection information and uses the slice based cell reselection information after a cell reselection to another cell.

Accordingly, the embodiments herein provide methods for handling a slice based cell reselection in a wireless network. The method includes determining, by a UE, at least one of a slice based cell reselection priority and a slice based cell reselection evaluation while the UE is in a camped normally state. Further, the method includes detecting, by the UE, that the UE changes a state from the camped normally state to another state. Further, the method includes stopping to determine, by the UE, at least one of the slice based cell reselection priority and the slice based cell reselection evaluation based on the detection.

Accordingly, the embodiments herein provide methods for handling a slice based cell reselection in a wireless network. The method includes receiving, by a UE, at least one of a new list of slices, a new list of slice groups, a changed list of slices, a change list of slice groups, at least one changed priority for the slices, at least one changed priority for the slice groups from a Non-access stratum (NAS) message or a UE internal communication from a NAS layer. Further, the method includes executing, by the UE, a cell reselection evaluation process based on the at least one of the new list of slices, the new list of slice groups, the changed list of slices, the changed list of slice groups, the at least one changed priority for the slices and the at least one changed priority for the slice groups received from the NAS message or the UE internal communication from the NAS layer.

Accordingly, the embodiments herein disclose a UE including a slice based cell reselection controller coupled with a processor and a memory. The slice based cell reselection controller is configured to receive a slice based cell reselection information from a dedicated signaling message. The slice based cell reselection information received from the dedicated signaling message includes a list of slice groups, at least one supporting frequency and at least one slice based priority for the at least one frequency supporting a slice group. Further, the slice based cell reselection controller is configured to receive a slice based cell reselection information from a broadcast signaling message. The slice based cell reselection information received from the broadcast signaling message includes a list of slice groups, at least one supporting frequency, at least one slice based priority for the at least one frequency, at least one priority for the at least one frequency supporting a slice group, and a list of physical cell identifiers of at least one cell supporting the slice groups or un-supporting the slice groups. Further, the slice based cell reselection controller is configured to store and apply the slice based cell reselection information received from the dedicated signaling message and a part of the slice based cell reselection information from the broadcast signaling message. Further, the slice based cell reselection controller is configured to avoid to store and apply the at least one slice based priority for at least one frequencies and the at least one priority for the at least one frequency received from the broadcast signaling message.

Accordingly, the embodiments herein provide a UE including a slice based cell reselection controller coupled with a processor and a memory. The slice based cell reselection controller is configured to receive a slice based cell reselection information comprising a list of slice groups, a list of frequencies supporting a slice group and at least one slice specific frequency priority from a dedicated signaling message. The UE has not received any slice based cell reselection information from a broadcast signaling message from a current serving cell. In an embodiment, the slice based cell reselection controller is configured to perform a slice based cell reselection by considering all neighbor cells in all frequencies support all slice groups while the UE is camped to a serving cell. In another embodiment, the slice based cell reselection controller is configured to consider that at least one neighbor cell does not support any of the slice groups provided in the dedicated signaling message so as to not perform the slice based cell reselection during the slice based cell reselection.

Accordingly, the embodiments herein provide a UE including a slice based cell reselection controller coupled with a processor and a memory. The slice based cell reselection controller is configured to determine at least one of a slice based cell reselection priority and a slice based cell reselection evaluation while the UE is in a camped normally state. Further, the slice based cell reselection controller is configured to detect that the UE changes a state from the camped normally state to another state. Further, the slice based cell reselection controller is configured to stop to determine at least one of the slice based cell reselection priority and the slice based cell reselection evaluation based on the detection.

Accordingly, the embodiments herein provide a UE including a slice based cell reselection controller coupled with a processor and a memory. The slice based cell reselection controller is configured to receive at least one of a new list of slices, a new list of slice groups, a changed list of slices, a change list of slice groups, at least one changed priority for the slices, at least one changed priority for the slice groups from a NAS message or a UE internal communication from a NAS layer. Further, the slice based cell reselection controller is configured to execute a cell reselection evaluation process based on the at least one of the new list of slices, the new list of slice groups, the changed list of slices, the changed list of slice groups, the at least one changed priority for the slices and the at least one changed priority for the slice groups received from the NAS message or the UE internal communication from NAS layer.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

According to various embodiments of the disclosure, cell reselection procedure can be efficiently enhanced by considering (network) slice.

The embodiments herein are to disclose methods and a UE for performing slice based cell reselection in wireless communication networks. The proposed method can be used to configure the slice based cell reselection information through the dedicated signalling so as to ensure the most appropriate information for the individual UEs which are available and ensure the validity over a large geographical area by allowing the UE to use the availability information locally broadcasted. The slice based information is applied for and only for the applicable scenarios such as camped normally state. The changes in the slice or the slice group related information is reflected quickly.

Another object of the embodiments herein is to provide that the UE determines a cell reselection priority using a slice group, frequency and priority information from a radio resource control (RRC) Release and applies a slice support check using the slice group, the frequency and an allowed-list/blocklist from a system information block (SIB).

Another object of the embodiments herein is to provide that the UE executes cell reselection evaluation process upon receiving a new list of slices from a non-access stratum (NAS) message or a changed list of slices or changed priorities for the slices from the NAS message or upon receiving a new list of slice groups from a NAS message or a changed list of slice groups or changed priorities for the slice groups from the NAS message.

Another object of the embodiments herein is to provide that the UE stops slice based cell reselection upon changing a state from camped normally state to other states.

Another object of the embodiments herein is to handle slice information from a RRC Release when SIB doesn't have the slice information.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates an overview of a wireless network for handling a slice based cell reselection, according to the embodiments as disclosed herein;

FIG. 2 illustrates a flow chart illustrating a method for handling a slice based cell reselection in the wireless network when a UE receives slice information from both system information and a RRC release, according to embodiments as disclosed herein;

FIG. 3 illustrates a flow chart illustrating a method for handling the slice based cell reselection in the wireless network when the UE receives the slice information from only the system information and not receive from the RRC release, according to embodiments as disclosed herein;

FIG. 4 illustrates a flow chart illustrating a method for handling the slice based cell reselection in the wireless network when the UE changes a state from a camped normally state to another state, according to embodiments as disclosed herein;

FIG. 5 illustrates a flow chart illustrating a method for handling the slice based cell reselection in the wireless network when the UE receives slice information from a NAS message or a UE internal communication from a NAS layer, according to embodiments as disclosed herein; and

FIG. 6 illustrates a block diagram of a terminal (or a user equipment (UE), according to embodiments of the present disclosure; and

FIG. 7 illustrates a block diagram of a base station according to embodiments of the present disclosure.

### MODE FOR THE INVENTION

Before undertaking the detailed descriptions below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The figures included herein, and the various embodiments used to describe the principles of the present disclosure are by way of illustration only and should not be construed in any way to limit the scope of the disclosure. Further, those skilled in the art will understand that the principles of the present disclosure may be implemented in any suitably arranged wireless communication system.

A most prominent feature of fifth generation (5G) networks lies in adopting network slicing for radio access networks (RANs) and core networks (CNs). This is intended for bundling up network resources and network functions into a single independent network slice depending on individual services, allowing for application of network system function and resource isolation, customization, independent management, and orchestration to mobile communication network architectures. The use of the network slicing enables offering 5G services in an independent and flexible way by selecting and combining 5G system network functions according to services, users, business models, or such references.

From TS 38.300 Release 16: The network slice always consists of a RAN part and a CN part. The support of the network slicing relies on a principle that traffic for different slices is handled by different Protocol Data Unit (PDU) sessions. The network can realize the different network slices by scheduling and also by providing different physical layer1 (L1)/physical layer2 (L2) configurations.

The network slicing is a concept to allow differentiated treatment depending on each customer requirements. With the network slicing, it is possible for Mobile Network Operators (MNO) to consider customers as belonging to different tenant types with each having different service requirements that govern in terms of what slice types each tenant is eligible to use based on Service Level Agreement (SLA) and subscriptions.

Some slices may be available only in part of the wireless network. The next-generation radio access network (NG-RAN) supported Single-Network Slice Selection Assistance Information (S-NSSAI) is configured by an Operations, administration, and management (OAM) entity. Awareness in the NG-RAN of the slices supported in cells of its neighbours may be beneficial for inter-frequency mobility in a connected mode. It is assumed that the slice availability does not change within a UE's registration area. The NG-RAN and a fifth generation core (5GC) are responsible to handle a service request for the slice that may or may not be available in a given area. Admission or rejection of access to the slice may depend by factors such as support for the slice, availability of resources, support of the requested service by the NG-RAN. In case the UE is associated with multiple slices simultaneously, only one signalling connection is maintained and for intra-frequency cell reselection, the UE always tries to camp on a best cell.

When some of the slices are supported only in some frequencies, till NR Release 16, the NR networks used, dedicated priorities to control the frequency on which the UE camps. In NR release 17, slice specific prioritization will be introduced. A serving cell can broadcast slice information including the slice support in the serving cell as well as neighboring frequencies, slice specific priorities for serving as well as neighboring frequencies, details on the slice availability in neighboring cells etc. There may be also some frequencies which may not be associated with any slices. The UE considers the slice priorities of the slices that it needs/supports along with the frequency priorities for the slices during cell reselection. The UE in in the RRC_IDLE or the RRC_INACTIVE may be in different states such as camped normally, any cell selection, camped on any cell etc.

Cell reselection: According to 3rd Generation Partnership Project (3GPP) specification TS 38.300, the cell reselection is a process that identifies the cell that the UE should camp on when the UE is in a non-connected state—i.e. radio resource control idle (RRC_IDLE) and RRC_INACTIVE. It is based on a cell reselection criteria. An inter-frequency cell reselection is based on absolute priorities where the UE tries to camp on the highest priority frequency available. It involves measurements of the serving and neighbour cells. The cell reselection can be speed dependent and in multi-beam operations, the cell quality is derived amongst the beams corresponding to the same cell.

From 3GPP TS 38.304, the absolute priorities of different NR frequencies or inter-RAT frequencies may be provided to the UE in a system information in a RRCRelease message, or by inheriting from another RAT at inter-RAT cell (re)selection. In the case of the system information, an NR frequency or inter-RAT frequency may be listed without providing a priority (i.e., the field cellReselectionPriority is absent for that frequency). If priorities are provided in dedicated signalling, the UE shall ignore all the priorities provided in the system information. If the UE is in camped on any cell state, the UE shall only apply the priorities provided by the system information from a current cell, and the UE preserves priorities provided by dedicated signalling and deprioritisationReq received in the RRCRelease unless specified otherwise. When the UE is configured to perform NR sidelink communication or a vehicle to everything (V2X) sidelink communication performs cell reselection, it may consider the frequencies providing the intra-carrier and inter-carrier configuration have equal priority in cell reselection.

Absolute priorities are used during cell reselection mainly as below:
1. If a neighbor frequency has lower or equal priority than a serving frequency, the UE measures the frequencies for the cell reselection only when the serving cell goes below certain threshold decided by the wireless network. If the neighbor frequency has higher priority than the serving frequency, then the UE measures those frequencies irrespective of serving frequency thresholds. The UE may further relax measurements based on the mobility of the UE or based on the distance of the UE from the serving cell. The network will provide thresholds and conditions for the UE to relax measurements. These conditions can be different for low priority and high priority frequencies.
2. The UE performs cell reselection evaluation based on different thresholds and different conditions depending on whether a neighbor frequency is having lower/equal/higher priority than the serving frequency. If there are multiple neighbor cells that satisfy cell reselection evaluation criteria, the UE reselects to a neighboring cells belonging to a higher priority frequency.
3. In the prior art, i.e. existing NR system, when the UE is camped normally, the UE executes the cell reselection evaluation process on the following triggers:
3-a) The UE internal triggers, so as to meet performance requirements.
3-b) When information on the system information used for the cell reselection evaluation procedure has been modified. The cell reselection evaluation process involves performing cell reselection measurements, evaluating the performed measurements according to the rules set by the network, ranking the cells, executing the cell reselection which will result in the UE moving to another cell.

Slice aware cell reselection: For slice aware cell reselection, the UE may use slice groups and a group of slices supported by same frequencies and is associated with same frequency priority. The slice groups are having same properties, i.e., are homogeneous within a Non-access stratum (NAS) registration area.

An NR UE RRC may receive a list of slices (or a list of slice groups—group of slices known as slicegroup), and/or slice priority-priority associated with a slice or slice group from a NAS layer. The NR UE RRC also may receive a list of sliceInformation, sliceInfo including an identifier for a slice or a slicegroup and a list of frequencies and the priority applicable for individual frequencies for this slice or slice group. There can be frequencies without priorities in the sliceInfo and such slices/slice groups may be considered as lowest frequency priority for this slice/slice group. In other words, the priority used for cell reselection is a combination of both slice priority and frequency priority.

There are two ways by which sliceInformation including the frequencies and frequency priorities associated with the slice/slice groups could be received by the UE such as one by broadcast signaling and other by dedicated signalling in a RRC messages like RRC release. If the UE is configured with slice specific frequency priority via a RRC Release message, the UE ignores all the slice specific priorities provided in the system information.

If the UE performs slice-based cell reselection and if the highest ranked cell of the said frequency does not support the highest priority slice supported by its frequency according to neighbouring cell's slice information then, the UE performs resorting, where re-sorting is defined as a change of frequency priority for reselection of a certain frequency requiring the UE to re-sort the ordered list of frequencies.

To aid the UE to identify whether the cells in the frequency supports different slices supported by the frequency, the network may provide the UE with a Physical Cell identifier (PCI) list (that is, list of physical cell identifiers of the cells that support the slice per frequency). The PCI list per slice group per frequency can be provided in the system information. The network can indicate one or two PCI lists known as block-list (“cells not supporting the corresponding slice group”) and/or allow-list (“cells supporting the corresponding slice group”).

The UE considers both slice priority and frequency priority for the cell reselection. The UE may derive slice based cell reselection priorities based on this slice priority along with frequency priority for each slice or slice group. For e.g., the UE may first consider slices/slice groups with higher slice priority. When more than one frequency has the same associated slice priority, the UE may consider frequency priority to prioritize those slices/slice groups. When there are frequencies not associated to any slice/slice groups, such frequencies may be considered a having lower priority than frequencies associated with the slice/slice groups. In addition to the steps for non-slice based cell reselection, the cell reselection evaluation process for slice based cell reselection includes derivation of slice based cell reselection priorities also.

The UE performs slice aware cell reselection using the slice priorities and the corresponding frequency priorities provided by the network. i.e., the UE performs the measurements and cell reselection evaluation considering the slice priorities and the associated frequency priorities. There are two ways by which the UE can receive the slice specific information, either through the broadcast through system information or through dedicated signaling like RRC Release.

Embodiments herein address the following problems with respect to slice based cell reselection:
a) If the UE has received information for slice specific cell reselection from both dedicated signalling and system information, what is the UE behavior in storing this information and utilizing this information?
b) As mentioned in the background, the UE may receive a list of slices and frequencies supporting this slice and the associated frequency priorities for those slices in two ways-broadcast signaling like system information or dedicated signaling through RRC messages like RRC Release. The UE performs slice aware reselection using priorities provided in the dedicated signalling and ignoring priorities from the broadcast signalling when the priorities are configured in the dedicated signalling. However additional information needed for the slice aware cell reselection like the list of slicegroups supported by the neighbour cell may not be provided to the UE in the dedicated signalling. It needs to be defined how the UE will perform slice aware reselection in such scenario.
c) The UE may receive the list of slices and frequencies supporting this slice and the associated frequency priorities in the dedicated signalling, but the broadcast signalling from the serving cell does not indicate the support of slice aware cell reselection. That is, it does not include any slice specific information including the list of slicegroups supported by a neighbor cell.
d) A UE RRC capable of slice aware cell reselection may receive an indication from UE NAS that slice or slicegroup information including the list of slices and slice groups and their priorities have changed. In some cases, the UE might have already stopped performing measuring some of the neighbor frequencies since they are low priority or because there is measurement relaxation configured. It needs to be defined as to how the UE handles this case.
e) The UE may transition out of “camped normally state” to any other states. It needs to be defined as to how the UE handles slice based cell reselection.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve method for handling a slice based cell reselection in a wireless network. The method includes receiving, by a UE, a slice based cell reselection information from a dedicated signaling message. The slice based cell reselection information includes a list of slice groups, at least one supporting frequency and at least one slice based priority for the at least one frequency supporting a slice group. Further, the method includes receiving, by the UE, a slice based cell reselection information from a broadcast signaling message. The slice based cell reselection information includes a list of slice groups, at least one supporting frequency, at least one slice based priority for the at least one frequency supporting a slice group, at least one priority for the at least one frequency, and a list of physical cell identifiers of at least one cell supporting the slice groups or un-supporting the slice groups. Further, the method includes storing and applying, by the UE, the slice based cell reselection in- formation received from the dedicated signaling message and a part of the slice based cell reselection information from the broadcast signaling message. Further, the method includes avoiding, by the UE, storing and applying the at least one slice based priority for at least one frequencies and the at least one priority for the at least one frequency received from the broadcast signaling message.

According to embodiments herein in the patent application, the slice can also mean slicegroups, a group of slices with similar behavior, with respect to slice aware cell reselection. The slice group also can mean slice in these embodiments.

In the patent disclosure, various methods are used for handling the slice specific prioritization information from a dedicated signaling.

In an embodiment, the UE which has received a slice based cell reselection information of one or more slices which includes a list of slice groups and a list of frequencies supporting the slice group and the associated slice specific frequency priorities applicable for this slice group through dedicated signalling (such as, but not limited to, RRC Release). Further, the UE receives the slice information of one or more slices, which includes a list of slice groups and a list of frequencies supporting the slice group and the associated slice specific frequency priorities applicable for this slice group and the list of physical cell identifiers supporting (or alternatively, a list of PCIs which are not supporting) this slice group through broadcast signaling like system information. Further, the UE stores and applies all the slice information from the dedicated signaling and a part of slice information from broadcast signaling from the current serving cell including list of slice groups, list of frequencies supporting this slice group and the list of physical cell identifiers supporting (or alternatively, a list of PCIs which are not supporting) this slice group for this frequency (i.e. allowed list or block-list). The UE does not store and apply the slice specific frequency priorities received from the broadcast signaling.

In another embodiment, when the UE has received the slice based cell reselection information including a list of slice groups, the list of frequencies supporting the slice group and the associated slice specific frequency priorities from RRC Release, but has not received any slice based cell reselection information from the current serving cell, the UE performs slice based cell reselection considering that all the successfully evaluated neighbor cells support all the slice groups provided in RRC Release.

In an embodiment, based on internal configurations, the UE which has received slice based cell reselection information including list of slice groups, list of frequencies supporting the slice group and the associated slice specific frequency priorities from the RRC Release, but has not received any slice based cell reselection information from the current serving cell, during slice based cell reselection considers that all the neighbor cells do not support any of the slice groups provided in RRC Release and doesn't perform slice based cell reselection. The UE keeps the slice based cell reselection information received from the RRC Release till a configured timer expires and may use it again after a cell reselection.

UE RRC handling of slice information change from NAS: In another embodiment, when the UE RRC receives a new list of slices or the slice groups from the NAS or when the list of slice or slice groups from the NAS changes or when the slice priority of the slice or slice groups received from the NAS changes, the UE executes the cell reselection evaluation process. While executing cell reselection, the UE re-derives the cell reselection priority for the frequencies considering the new list of slice/slice groups from the NAS and restarts the measurement process based on the newly derived cell reselection priorities.

UE not in camped normally state: In another embodiment, when the UE moves out of camped normally state, it stops slice based cell reselection. The UE stops deriving reselection priorities or priority order while moving out of camped normally state.

In an embodiment, if any fields with cellReselectionPriority or nsag-CellReselectionPriority are provided in the dedicated signalling, the UE shall ignore any fields with cellReselectionPriority and nsag-CellReselectionPriority provided in the system information.

In an embodiment, the UE considers the cell on a NR frequency to support all slices of a slice group (also known as Network Slice Access Group, NSAG if the cell is either listed in the sliceAllowedCellListNR (if provided in the used slice-based cell reselection information) or the cell is not listed in a sliceExcludedCellListNR (if provided in the used slice-based cell reselection information).

When the NSAG-Frequency pair configured in dedicated slice information is not available in the SIB 16, consider the below options
1. The UE doesn't use a NSAG-Frequency pair for deriving slice based cell reselection priority in the cell.
2. The UE derives a slice based cell reselection priority assuming all the cells in the frequency support the NSAG.

The proposed method can be used to configure the slice based cell reselection information through the dedicated signalling so as to ensure the most appropriate information for the individual UEs which are available and ensure the validity over a large geographical area by allowing the UE to use the availability information locally broadcasted. The slice based information is applied for and only for the applicable scenarios such as camped normally state. The changes in the slice or the slice group related information is reflected quickly.

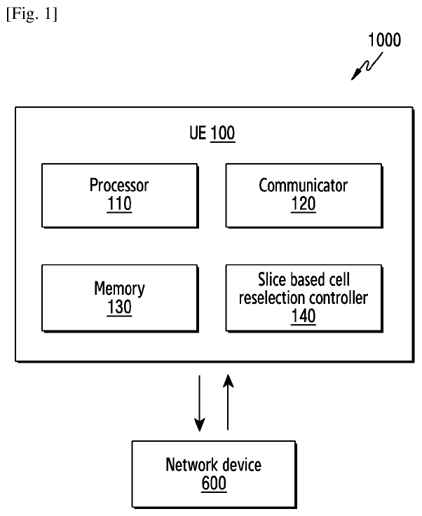

Referring now to the drawings, and more particularly to FIGS. 1 through 5, where similar reference characters denote corresponding features consistently throughout the figures, there are shown at least one embodiment.

FIG. 1 shows an overview of a wireless network (1000) for handling a slice based cell reselection, according to the embodiments as disclosed herein. The wireless network (1000) can be, for example, but not limited to a fourth generation wireless network, a fifth generation wireless network, Open Radio Access Network (ORAN) or the like. The wireless network (1000) includes a UE (100) and a network device (600). The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network device (600) can be, for example, but not limited to a gNB, a eNB, a new radio (NR) base station or the like. The network device (600) can also be referred as a base station and a transceiver. In an embodiment, the UE (100) includes a processor (110), a communicator (120), a memory (130) and a slice based cell reselection controller (140). The processor (110) is coupled with the communicator (120), the memory (130) and the slice based cell reselection controller (140).

In an embodiment, the slice based cell reselection controller (140) receives a slice based cell reselection information from the dedicated signaling message. The slice based cell reselection information received from the dedicated signaling message includes a list of slice groups, at least one supporting frequency and at least one slice based priority for the at least one frequency supporting a slice group. Further, the slice based cell reselection controller (140) receives a slice based cell reselection information from a broadcast signaling message. The slice based cell reselection information received from the broadcast signaling message includes a list of slice groups, at least one supporting frequency, at least one slice based priority for the at least one frequency supporting the slice group, at least one priority for the at least one frequency supporting the slice group, and a list of physical cell identifiers of at least one cell supporting the slice groups or un-supporting the slice groups. Further, the slice based cell reselection controller (140) stores and applies the slice based cell reselection information received from the dedicated signaling message and a part of the slice based cell reselection information from the broadcast signaling message. The part of the slice based cell reselection information stored and applied from the broadcast in- formation includes the list of slice groups, the at least one supporting frequency, and the list of physical cell identifiers supporting or un-supporting the slice group. Further, the slice based cell reselection controller (140) avoids to store and apply the at least one slice based priority for at least one frequencies and the at least one priority for the at least one frequency received from the broadcast signaling message.

In another embodiment, the slice based cell reselection controller (140) receives the slice based cell reselection information including the list of slice groups, the list of frequencies supporting the slice group and at least one slice specific frequency priority from the dedicated signaling message. The UE (100) has not received any slice based cell reselection information from the broadcast signaling message from a current serving cell (not shown). In an embodiment, the slice based cell reselection controller (140) performs the slice based cell reselection by considering all neighbor cells in all frequencies support all slice groups while the UE (100) is camped to a serving cell. In another embodiment, the slice based cell reselection controller (140) considers that at least one neighbor cell does not support any of the slice groups provided in the dedicated signaling message so as to not perform the slice based cell reselection during the slice based cell reselection. Further, the slice based cell reselection controller (140) keeps the slice based cell reselection information received from the dedicated signaling message while the UE (100) is not performing the slice based cell reselection in the serving cell which doesn't broadcast slice based cell reselection information and uses the slice based cell reselection information after the UE performs the cell reselection to another cell.

In another embodiment, the slice based cell reselection controller (140) determines at least one of the slice based cell reselection priority and the slice based cell reselection evaluation while the UE (100) is in the camped normally state. Further, the slice based cell reselection controller (140) detects that the UE (100) changes the state from the camped normally state to another state. Further, the slice based cell reselection controller (140) stops to determine at least one of the slice based cell reselection priority and the slice based cell reselection evaluation based on the detection.

In another embodiment, the slice based cell reselection controller (140) receives at least one of the new list of slices, the new list of slice groups, the changed list of slices, the change list of slice groups, at least one changed priority for the slices, at least one changed priority for the slice groups from a Non-access stratum (NAS) message or a UE internal communication from a NAS layer. Further, the slice based cell reselection controller (140) executes a cell reselection evaluation process based on the at least one of the new list of slices, the new list of slice groups, the changed list of slices, the changed list of slice groups, the at least one changed priority for the slices and the at least one changed priority for the slice groups received from the NAS message or the UE internal communication from the NAS layer.

The slice based cell reselection controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 1 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

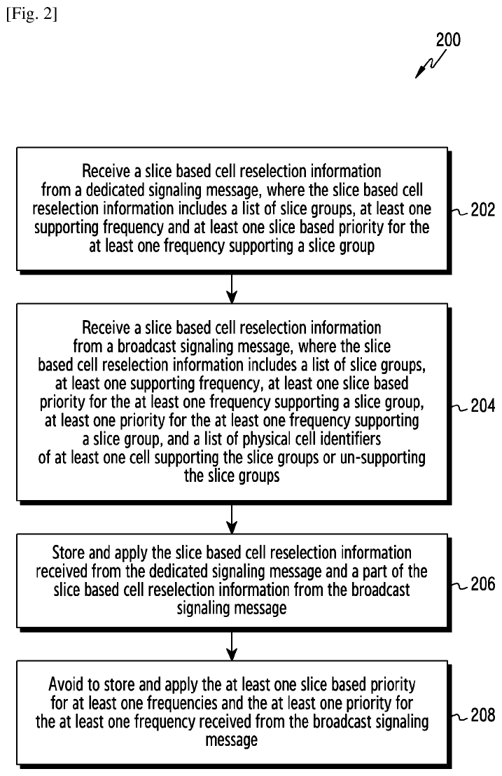

FIG. 2 is a flow chart (200) illustrating a method for handling the slice based cell reselection in the wireless network (1000) when the UE (100) receives the slice information from both system information and the RRC release (or broadcast signaling message), according to embodiments as disclosed herein. The operations (202-208) are handled by the slice based cell reselection controller (140).

At 202, the method includes receiving the slice based cell reselection information from the dedicated signaling message. The slice based cell reselection information includes the list of slice groups, the at least one supporting frequency and at least one slice based priority for the at least one frequency supporting the slice group. At 204, the method includes receiving the slice based cell reselection information from the broadcast signaling message. The slice based cell reselection information received from the broadcast signaling message includes the list of slice groups, the at least one supporting frequency, the at least one slice based priority for the at least one frequency, the at least one priority for the at least one frequency supporting the slice group, and the list of physical cell identifiers of at least one cell supporting the slice groups or un-supporting the slice groups. At 206, the method includes storing and applying the slice based cell reselection information received from the dedicated signaling message and the part of the slice based cell reselection information from the broadcast signaling message. At 208, the method includes avoiding to store and apply the at least one slice based priority for at least one frequencies and the at least one priority for the at least one frequency received from the broadcast signaling message.

FIG. 3 is a flow chart (300) illustrating a method for handling the slice based cell reselection in the wireless network (1000) when the UE (100) receives the slice information from only the system information and not receive from the RRC release, according to embodiments as disclosed herein. The operations (302-306) are handled by the slice based cell reselection controller (140).

At 302, the method includes receiving the slice based cell reselection information including the list of slice groups, the list of frequencies supporting the slice group and at least one slice specific frequency priority from the dedicated signaling message. The UE (100) has not received any slice based cell reselection information from a broadcast signaling message from the current serving cell. At 304, the method includes performing at least one of: performing a slice based cell reselection by considering all neighbor cells in all frequencies support all slice groups while the UE (100) is camped to a serving cell. At 306, the method includes considering that at least one neighbor cell does not support any of the slice groups provided in the dedicated signaling message so as to not perform the slice based cell reselection during the slice based cell reselection.

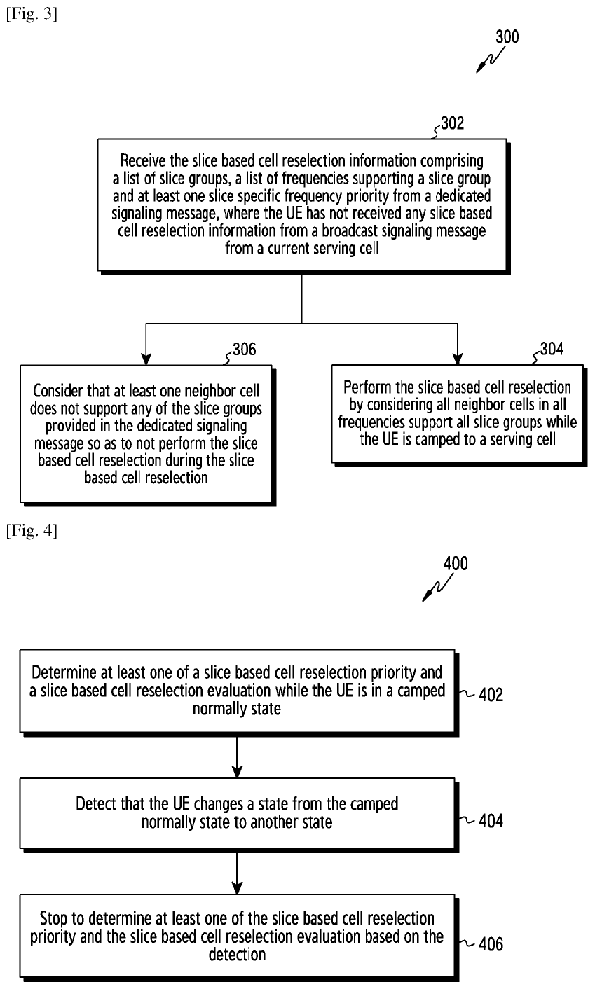

FIG. 4 is a flow chart (400) illustrating a method for handling the slice based cell reselection in the wireless network (1000) when the UE (100) changes the state from the camped normally state to another state, according to embodiments as disclosed herein. The operations (402-406) are handled by the slice based cell reselection controller (140).

At 402, the method includes determining at least one of the slice based cell reselection priority and a slice based cell reselection evaluation while the UE (100) is in the camped normally state. At 404, the method includes detecting that the UE (100) changes a state from the camped normally state to another state. At 406, the method includes stopping to determine at least one of the slice based cell reselection priority and the slice based cell reselection evaluation based on the detection.

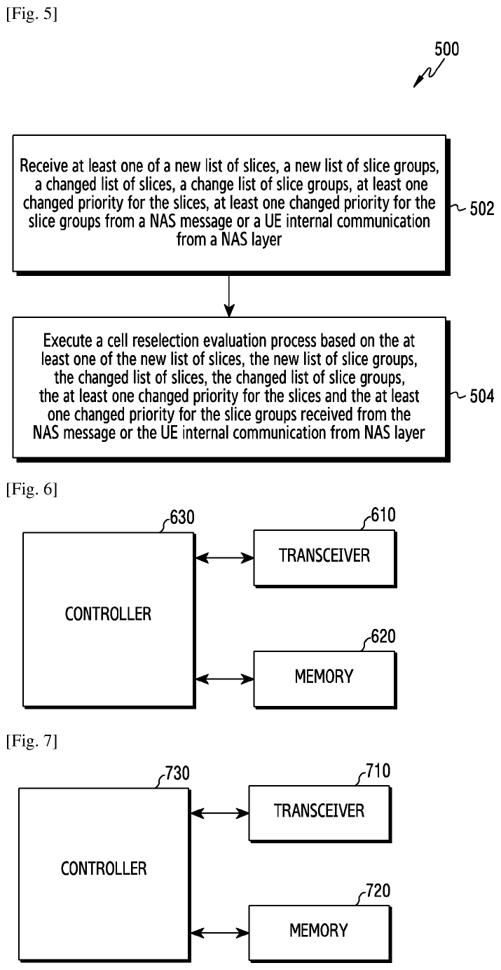

FIG. 5 is a flow chart (500) illustrating a method for handling the slice based cell reselection in the wireless network (1000) when the UE (100) receives the slice information from the NAS message or the UE internal communication from the NAS layer, according to embodiments as disclosed herein. The operations (502-504) are handled by the slice based cell reselection controller (140).

At 502, the method includes receiving at least one of the new list of slices, the new list of slice groups, the changed list of slices, the change list of slice groups, at least one changed priority for the slices, at least one changed priority for the slice groups from the NAS message or the UE internal communication from the NAS layer. At 504, the method includes executing a cell reselection evaluation process based on the at least one of the new list of slices, the new list of slice groups, the changed list of slices, the changed list of slice groups, the at least one changed priority for the slices and the at least one changed priority for the slice groups received from the NAS message or the UE internal communication from the NAS layer.

The various actions, acts, blocks, steps, or the like in the flow charts may be performed in the order presented, in a different order or simultaneously. Further, in some embodiments, some of the actions, acts, blocks, steps, or the like may be omitted, added, modified, skipped, or the like without departing from the scope of the invention.

FIG. 6 illustrates a block diagram of a terminal (or a user equipment (UE)), according to embodiments of the present disclosure.

As shown in FIGURE. 6, a terminal according to an embodiment may include a transceiver 610, a memory 620, and a controller 630. The transceiver 610, the memory 620, and the controller 630 of the terminal may operate according to a communication method of the terminal described above. However, the components of the terminal are not limited thereto. For example, the terminal may include more or fewer components than those described in FIG. 6. In addition, the controller 630, the transceiver 610, and the memory 620 may be implemented as a single chip. Also, the controller 630 may include at least one processor.

The transceiver 610 collectively refers to a terminal station receiver and a terminal transmitter, and may transmit/receive a signal to/from a base station or another terminal. The signal transmitted or received to or from the terminal may include control information and data. The transceiver 610 may include a RF transmitter for up- converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the controller 630, a signal through a wireless channel, and transmit a signal output from the controller 630 through the wireless channel.

The memory 620 may store a program and data required for operations of the terminal. Also, the memory 620 may store control information or data included in a signal obtained by the terminal. The memory 620 may be a storage medium, such as read-only memory (ROM), random access memory (RAM), a hard disk, a CD-ROM, and a DVD, or a combination of storage media.

The controller 630 may control a series of processes such that the terminal operates as described above. For example, the controller 630 may transmit a data signal and/or a control signal to a base station, and the controller 630 may receive a data signal and/or a control signal from a base station.

FIG. 7 illustrates a block diagram of a base station, according to embodiments of the present disclosure.

As shown in FIGURE. 7 is, the base station of the present disclosure may include a transceiver 710, a memory 720, and a controller 730. The transceiver 710, the memory 720, and the controller 730 of the base station may operate according to a communication method of the base station described above. However, the components of the base station are not limited thereto. For example, the base station may include more or fewer components than those described in FIG. 7. In addition, the controller 730, the transceiver 710, and the memory 720 may be implemented as a single chip. Also, the controller 730 may include at least one processor.

The transceiver 710 collectively refers to a base station receiver and a base station transmitter, and may transmit/receive a signal to/from a terminal, another base station, and/or a core network function(s) (or entity(s)). The signal transmitted or received to or from the base station may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the controller 730, a signal through a wireless channel, and transmit a signal output from the controller 730 through the wireless channel.

The memory 720 may store a program and data required for operations of the base station. Also, the memory 720 may store control information or data included in a signal obtained by the base station. The memory 720 may be a storage medium, such as ROM, RAM, a hard disk, a CD-ROM, and a DVD, or a combination of storage media.

The controller 730 may control a series of processes such that the base station operates as described above. For example, the controller 730 may receive a data signal and/or a control signal from a terminal, and the controller 730 may transmit a data signal and/or a control signal to a terminal.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the present disclosure. Another storage device on the communication network may also be connected to the apparatus performing the embodiments of the present disclosure.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an clement expressed in a plural form may also be configured as a single element, and an element expressed in a singular form may also be configured as plural elements.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1. A method performed by a terminal in a wireless communication system, the method comprising:
receiving, from a base station, a radio resource control (RRC) release message including information on a first cell reselection priority for slicing;
receiving, from the base station, a system information block (SIB) for configuring a slice-based cell reselection, the SIB including information on a second cell reselection priority for slicing, information on a carrier frequency associated with the slice-based cell reselection, and information on a slice group; and
identifying a cell reselection priority for the slice-based cell reselection, based on the first cell reselection priority for slicing, the carrier frequency associated with the slice-based cell reselection, and the slice group.

2. The method of claim 1, wherein the second cell reselection priority for slicing is ignored for the slice-based cell reselection.

3. The method of claim 1, wherein the cell reselection priority is identified in case that the terminal is in a camped normally state, and wherein a cell reselection evaluation is performed in case that the terminal is in the camped normally state and the slice group changes.

4. The method of claim 1, wherein the SIB further comprises information on at least one of an allowed cell list or an excluded cell list associated with the slice group.

5. A method performed by a base station in a wireless communication system, the method comprising:
transmitting, to a terminal, a radio resource control (RRC) release message including information on a first cell reselection priority for slicing; and
transmitting, to the terminal, a system information block (SIB) for configuring a slice-based cell reselection, the SIB including information on a second cell reselection priority for slicing, information on a carrier frequency associated with the slice-based cell reselection, and information on a slice group,
wherein a cell reselection priority for the slice-based cell reselection is based on the first cell reselection priority for slicing, the carrier frequency associated with the slice-based cell reselection, and the slice group.

6. The method of claim 5, wherein the second cell reselection priority for slicing is ignored for the slice-based cell reselection.

7. The method of claim 5, wherein a cell reselection evaluation is performed in case that the slice group changes, and
wherein the SIB further comprises information on at least one of an allowed cell list or an excluded cell list associated with the slice group.

8. A terminal in a wireless communication system, the terminal comprising:
a transceiver; and
a controller coupled with the transceiver and configured to:
receive, from a base station, a radio resource control (RRC) release message including information on a first cell reselection priority for slicing,
receive, from the base station, a system information block (SIB) for configuring a slice-based cell reselection, the SIB including information on a second cell reselection priority for slicing, information on a carrier frequency associated with the slice-based cell reselection, and information on a slice group, and
identify a cell reselection priority for the slice-based cell reselection, based on the first cell reselection priority for slicing, the carrier frequency associated with the slice-based cell reselection, and the slice group.

9. The terminal of claim 8, wherein the second cell reselection priority for slicing is ignored for the slice-based cell reselection.

10. The terminal of claim 8, wherein the cell reselection priority is identified in case that the terminal is in a camped normally state, and wherein a cell reselection evaluation is performed in case that the terminal is in the camped normally state and the slice group changes.

11. The terminal of claim 8, wherein the SIB further comprises information on at least one of an allowed cell list or an excluded cell list associated with the slice group.

12. A base station in a wireless communication system, the base station comprising:
a transceiver; and
a controller coupled with the transceiver and configured to:
transmit, to a terminal, a radio resource control (RRC) release message including information on a first cell reselection priority for slicing, and transmit, to the terminal, a system information block (SIB) for configuring a slice-based cell reselection, the SIB including information on a second cell reselection priority for slicing, information on a carrier frequency associated with the slice-based cell reselection, and information on a slice group,
wherein a cell reselection priority for the slice-based cell reselection is based on the first cell reselection priority for slicing, the carrier frequency associated with the slice-based cell reselection, and the slice group.

13. The base station of claim 12, wherein the second cell reselection priority for slicing is ignored for the slice-based cell reselection.

14. The base station of claim 12, wherein a cell reselection evaluation is performed in case that the slice group changes.

15. The base station of claim 12, wherein the SIB further comprises information on at least one of an allowed cell list or an excluded cell list associated with the slice group.
